(19) United States
(12) Patent Application Publication
(10) Pub. No.: US 2004/0046871 A1
(43) Pub. Date: Mar. 11, 2004

(54) Photographing apparatus, photographing restrain system, and photographing restrain release system

(76) Inventors: Katsuei Ichikawa, Yokohama (JP); Akio Yamamoto, Hiratsuka (JP); Yutaka Igarashi, Yokohama (JP)

Correspondence Address: MCDERMOTT, WILL & EMERY, 600 13th Street, N.W., Washington, DC, 20005-3096, US

(21) Appl. No.: 10/464,832

(22) Filed: Jun. 19, 2003

(30) Foreign Application Priority Data
Jun. 20, 2002 (JP) 2002-179472

(51) Int. Cl. H04N 5/225

(52) U.S. Cl. 348/207.99

(57) ABSTRACT

Disclosed herein is a photographing apparatus or a portable terminal equipped with a photographing apparatus which surely restrains one from taking pictures in any area where photographing is prohibited. When the CCD camera 107 is turned on and the portable communication terminal 103 is set in the photographing mode, the short-distance wireless communication unit 113 is also turned on so that it is ready to receive photographing restrain information wirelessly transmitted from the photographing restrain information transmitting unit 101. If the short-distance wireless communication unit 113 receives photographing restrain information other than “photographing—prohibited”, then the control unit 117 controls the CCD camera based on the photographing restrain information, thereby permitting photographing the object 105 under some restrain.

### BACKGROUND OF THE INVENTION

1. Field of the Invention

The present invention relates to an improvement of the technology to effectively restrain a photographing apparatus from operation when someone intends to take a forbidden object or to take pictures in a forbidden area. The term “photographing apparatus” used herein means a digital still camera (digital camera for short), a digital video camera, and a portable communication terminal equipped with a digital camera.

2. Description of the Prior Art

The recent development of digital technology has greatly affected the technological innovation relating to the digital camera and digital video camera. The highly improved performance and significantly reduced size have permitted the digital camera to be built into a portable communication terminal, such as portable telephone and PHS terminal. At present, such a portable communication terminal functions as a visual telephone because it can transmit through mobile communication networks the data of still pictures taken by a digital camera. On the other hand, a digital video camera permits the moving pictures it takes to be reproduced in real time on the display unit of a portable communication terminal or a personal computer by transmitting the data of moving pictures through mobile communication networks.

In urban communities, there are facilities such as theaters (or movie theaters) and banks, where photographing is prohibited from the standpoint of copyright protection and security. There are also facilities such as sports stadiums and zoological gardens, where flash photographing is forbidden to avoid adverse effects on players and animals. In addition, some administrators of art galleries and museums are planning to charge those who take pictures in forbidden areas.

Unfortunately, it would be difficult to completely restrain everybody from photographing in such facilities because the portable communication terminal is so small that its user can easily bring it into forbidden areas and photograph forbidden objects without being noticed. Moreover, the portable communication terminal mentioned above permits its user to transmit the image data of pictures of forbidden objects to another terminal immediately after photographing. Then it permits its user to erase the image data from it (digital camera). In such a case it would be difficult to prove the stealthy photographing.

The portable communication terminal equipped with a digital camera as mentioned above is so constructed as to produce a mimic shutter sound when its user takes a picture, so that it warns that someone near it is being photographed. This provision is designed to protect the subject's right of portrait; however, it is not so effective because the mimic shutter sound cannot be made so loud as to annoy surroundings. On the other hand, a digital video camera emits light from an LED mounted near the lens when it is in operation, thereby letting the subject know that he or she is being photographed. However, this provision is not intended to prevent stealthy photographing.

Thus, it is difficult to surely restrain one from photographing (with or without flash) forbidden subjects with a digital camera built into a portable communication terminal or a digital video camera which has the provision as mentioned above. Such conventional cameras, therefore, pose problems with infringement of copyright and portrait right and with securities. Moreover, they easily permit stealthy photographing because they do not fully inform the subject (and surroundings) that he or she is being photographed.

### SUMMARY OF THE INVENTION

It is an object of the present invention to provide a photographing apparatus or a portable terminal equipped with a photographing apparatus which surely restrains one from taking pictures in any area where photographing is prohibited.

According to one aspect of the present invention, the photographing apparatus consists of an electrically controlled photographing unit, a signal receiving unit to receive signals from an external remote unit, and a photographing control unit which controls the operation of the photographing unit (or controls actions relating to photographing operation) in response to control signals which are output from the signal receiving unit to control the photographing unit.

Other and further objects, features and advantages of the invention will appear more fully from the following description.

### BRIEF DESCRIPTION OF THE DRAWINGS

FIG. 1 is a block diagram showing the first embodiment of the photographing restrain system according to the present invention.

FIG. 2 is a block diagram showing the second embodiment of the photographing restrain system according to the present invention.

FIG. 3 is a block diagram showing the third embodiment of the photographing restrain system according to the present invention.

FIG. 4 is a flowchart showing operations in each unit of the photographing restrain system of FIG. 3.

FIG. 5 is a block diagram showing one embodiment of the photographing warning system according to the present invention.

FIG. 6 is a diagram illustrating by example the photographing restrain system of the present invention which is used in an outdoor area where unconditional photographing is prohibited.

FIG. 7 is a diagram illustrating by another example the photographing restrain system of the present invention which is used in an outdoor area where unconditional photographing is prohibited.

FIG. 8 is a flowchart showing operations in each unit of the photographing restrain system of FIG. 7.

FIG. 9 is a diagram illustrating by example the commercial information providing system that employs the portable communication terminal according to the present invention.

FIG. 10 is a flowchart showing operations in each unit of the commercial information providing system of FIG. 9.

FIG. 11 is a diagram illustrating by example the photographing restrain release system that employs the portable communication terminal according to the present invention.

FIG. 12 is a flowchart showing operations in each unit of the photographing restrain release system of FIG. 11.

### DESCRIPTION OF THE PREFERRED EMBODIMENTS

The invention will be described in more detail with reference to the accompanying drawings.

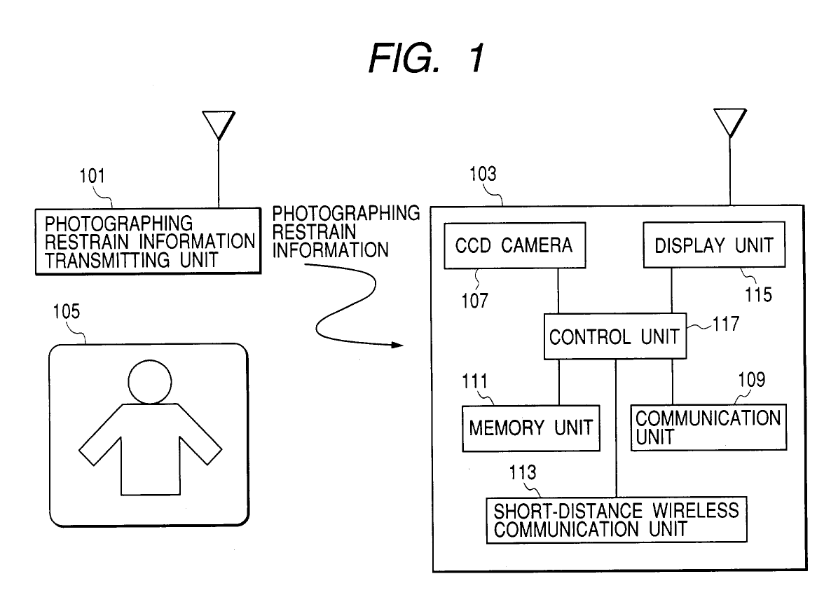

FIG. 1 is a block diagram showing the first embodiment of the photographing restrain system according to the present invention.

The photographing restrain system is installed in such facilities as theaters (or movie theaters) and banks, where photographing is prohibited for copyright protection or securities. As shown in FIG. 1, it consists of a photographing restrain information transmitting unit 101 and a portable communication terminal 103. The former is positioned near a subject 105 to be photographed. It transmits wirelessly the photographing restrain information regarding the subject 105. Such information includes whether or not photographing (with flash) is permitted and how many pictures are allowed. In other words, the subject 105 has limits previously imposed on permission of photographing, number of pictures, and use of flash. Incidentally, the photographing restrain information transmitting unit 101 has a memory unit to previously store the photographing restrain information mentioned above, a wireless transmitter to send the photographing restrain information stored in the memory, and a control unit for them, which are not shown in FIG. 1. On the other hand, the portable communication terminal 103 (which receives the photographing restrain information) consists of a communication unit 109, a memory unit 111, a short-distance wireless communication unit 113, a display unit 115, and a control unit 117. It also has a digital camera or CCD camera 107.

The CCD camera 107 in the portable communication terminal 103 takes a photograph of the subject 105 under control by the control unit 117. The communication unit 109 interchanges information, under control by the control unit 117, with portable communication terminals (not shown) and information processing terminals such as personal computers (not shown) through mobile communication networks. The memory unit 111 stores, under control by the control unit 117, image data of the subject 105 photographed by the CCD camera 107 and any other various data received by the communication unit 109 from portable communication terminals (not shown) through mobile communication networks.

The short-distance wireless communication unit 113 transmits in non-contact mode, under control by the control unit 117, various data read from the memory unit 111 by the control unit 117 directly to other portable communication terminals (not shown) in the neighborhood of the portable communication terminal 103. In addition, the short-distance wireless communication unit 113 also receives, under control by the control unit 117, the photographing restrain information regarding the subject 105 which has been wirelessly transmitted from the photographing restrain information transmitting unit 101 and outputs the photographing restrain information to the memory unit 111 through the control unit 117. In this embodiment, the short-distance wireless communication unit 113 employs Bluetooth (a trademark of Bluetooth SIG, Inc. USA).

The display unit 115 displays, under control by the control unit 117, image data of the subject 105 photographed by the CCD camera 107, and it also display in a prescribed mode various data received by the communication unit 109 from other portable communication terminals (not shown) through mobile communication networks. The control unit 117 controls the CCD camera 107, the communication unit 109, the memory unit 111, the short-distance wireless communication unit 113, and the display unit 115.

The following deals with the flow of processing that takes place in the photographing restrain system when the subject 105 is photographed by the CCD camera 107 of the portable communication terminal 103. (As mentioned above, the subject 105 is under some restrain in permission of picture taking and flash use and the number of pictures.)

In FIG. 1, the photographing restrain information transmitting unit 101 wirelessly transmits continuously or intermittently the above-mentioned photographing retrain information about the subject 105. On the other hand, in the portable communication terminal 103, the short-distance wireless communication unit 113 becomes ready to receive the photographing retrain information which is wirelessly transmitted from the photographing restrain information transmitting unit 101 as the user turns on the CCD camera 107 and sets the portable communication terminal 103 in photographing mode (and also turns on the short-distance wireless communication unit 113).

If the short-distance wireless communication unit 113 in its stand-by state receives photographing restrain information other than “photographing—prohibited”, then the control unit 117 controls the CCD camera 107 based on such photographing restrain information, thereby permitting it to take pictures of the subject 105. Incidentally, if the short-distance wireless communication unit 113 in its stand-by state does not receive the photographing restrain information, then the CCD camera 107 of the portable communication terminal 103 performs photographing in the usual way under control by the control unit 117. Photographing restrains other than “photographing—prohibited” will be explained later one by one.

When the control unit 117 recognizes that the above-mentioned photographing restrain information is “photographing—prohibited” (or taking a picture of the subject 105 is prohibited), then the control unit 117 sends the CCD camera 107 a command to prevent its photographing action. As an alternative, it would be possible to prevent the control unit 117 from writing in the memory unit 111 the image data of the subject 105 taken by the CCD camera 107, instead of preventing the CCD camera 107 from taking pictures.

Next, when the control unit 117 recognizes that the above-mentioned photographing restrain information is “limited pictures” (or photographing the subject 105 is limited in the number of pictures), then the control unit 117 adds the number of pictures (image data) taken by the CCD camera 107. Upon recognizing that the added value has reached the previously set number of pictures, the control unit 117 controls the CCD camera 107 to suspend its photographing action.

Furthermore, when the control unit 117 recognizes that the above-mentioned photographing restrain information contains any command to display the restrain regarding the photographing of the subject 105 in addition to the “limited pictures” information and the “flash—prohibited”information, then the control unit 117 causes the display unit 115 to display such information in response to the command. Also, when the control unit 117 recognizes that the above-mentioned photographing restrain information contains any command to display the prohibition of the photographing of the subject 105 in addition to “photographing—prohibited” (or taking a picture of the subject 105 is prohibited), then the control unit 117 causes the display unit 115 to display such information (“photographing—prohibited”) in response to the command.

In this case, the control unit 117 disables the photographing action of the CCD camera 107 or the control unit 117 restrains itself from writing image data (of pictures taken by the CCD camera 107) into the memory unit 111. Alternatively, the control unit 117 may merely indicate on the display unit 111 that the photographing of the subject 105 is prohibited instead of disabling the photographing action or any other actions relating to photographing.

Incidentally, the photographing restrain information transmitting unit 101 may be operated such that the transmission level of the photographing restrain information to be transmitted therefrom is adjusted to such an extent that unless the user approaches within several meters from the subject 105, the user's portable communication terminal 103 cannot receive such information. In this way it is possible to avoid an erratic operation of the portable communication terminal 103 when a user takes a picture of anything other than the subject 105 in the vicinity of the subject 105. In addition, the photographing restrain information transmitting unit 101 with a controlled low transmission level as mentioned above is effective in any facility (such as a movie theater in which photographing is entirely prohibited), if a plurality of such units are arranged in the facility so that the portable communication terminal 103 can receive the photographing restrain information at any place in the facility.

Incidentally, a wrong-minded person may attempt to escape the photographing restrain by covering the portable communication terminal 103 (except for the CCD camera 107) with a radio wave shielding material so that the short-distance wireless communication unit 113 cannot receive the photographing restrain information from the photographing restrain information transmitting unit 101. However, such an attempt will be foiled if the portable communication terminals 103 is constructed as follows. That is, the CCD camera 107 is placed near the antenna of the short-distance wireless communication unit 113 in the casing of the portable communication terminal 103 so that the CCD camera is also covered if the antennal is covered with a radio wave shielding material. If the CCD camera 107 is placed near the antenna of the short-distance wireless communication unit 113 in the casing of the portable communication terminal 103 as mentioned above, it is impossible to shut out the radio wave of photographing restrain information entering the short-distance wireless communication unit 113 unless the CCD camera 107 is also covered with the radio wave shielding material. The same effect as above may also be produced when the short-distance wireless communication unit 113 is based on wireless LAN or even when radio wave is replaced by infrared data communication conforming to IrDA (Infrared Data Association).

As mentioned above, according to the first embodiment of the present invention, the photographing restrain system is constructed such that the short-distance wireless communication unit 113 built into the portable communication terminal 103 receives the photographing restrain information which is wirelessly transmitted from the photographing restrain information transmitting unit 101 and then it outputs signals to the control unit 117 which controls each part of the portable communication terminal 103. With this system, it is possible to certainly restrain the portable communication terminal 103 equipped with a photographing mechanism from taking pictures (or using a flash) in some facilities, such as theaters, movie theaters, and banks, where photographing or flashing is prohibited. Thus it is possible to solve problems with securities in banks and problems with infringement of copyright and portrait right. In addition, it would be possible to charge for photographing in art galleries. Incidentally, according to this embodiment, the photographing restrain information transmitting unit 101 is arranged near the subject 105 as mentioned above. However, it may be carried by an attendant in the facility concerned. Moreover, this embodiment may also be applicable to a digital video camera as well as the portable communication terminal 103 equipped with the CCD camera 107.

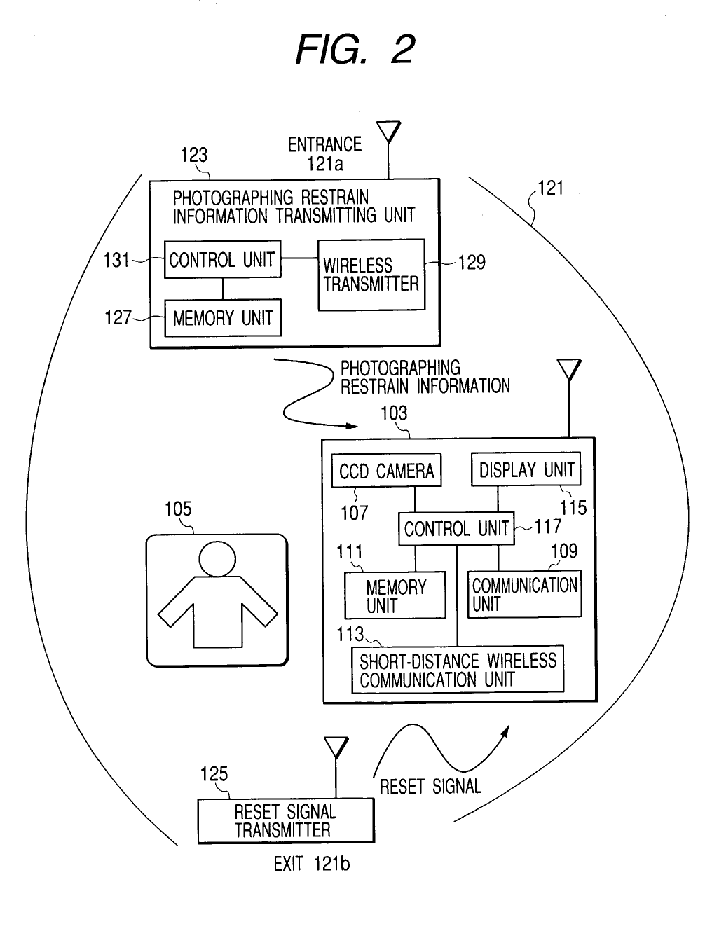

FIG. 2 is a block diagram showing the second embodiment of the photographing restrain system according to the present invention.

This photographing restrain system is to be installed in a facility (such as theater and movie theater) where photographing is prohibited in full measure. It consists of the portable communication terminal 103 (shown in FIG. 1), the photographing restrain information transmitting unit 123, and the reset signal transmitter 125. The subject is indicated by 105.

The photographing restrain information transmitting unit 123 functions in almost the same way as the photographing restrain information transmitting unit 101 shown in FIG. 1. As shown in FIG. 2, it is arranged at the entrance 121a or in the neighborhood of the entrance 121a of the area in which photographing is prohibited. It wirelessly transmits the photographing restrain information continuously or intermittently to the portable communication terminal 103 in the area 121 where photographing is prohibited. The photographing restrain information transmitting unit 123 is equipped with a memory unit 127 to previously store the photographing restrain information mentioned above, a wireless transmitter 129 to send the photographing restrain information stored in the memory unit, and a control unit 131 to control the memory unit 127 and the wireless transmitter 129.

On the other hand, the reset signal transmitter 125 is arranged at the exit 121b or in the neighborhood of the exit 121b of the area 121 where photographing is prohibited. It wirelessly transmits to the portable communication terminal 103 a reset signal to remove restrains imposed on the portable communication terminal 103 according to the photographing restrain information transmitted from the photographing restrain information transmitting unit 123.

The photographing restrain system constructed as mentioned above works in the following manner when a user carrying the portable communication terminal 103 enters the area 121 where photographing is prohibited.

In FIG. 2, it is assumed that a user carrying the portable communication terminal 103 enters the area 121 where photographing is prohibited through the entrance 121a. The short-distance wireless communication unit 113 of the portable communication terminal 103 receives the photographing restrain information (for the subject 105) which is transmitted from the wireless transmitter 129 of the photographing restrain information transmitting unit 123. The thus received information is downloaded to the memory unit 111 of the portable communication terminal 103. Consequently, when the user takes pictures using the portable communication terminal 103 in the area 121 where photographing is prohibited, the control unit 117 restricts the action of the CCD camera 107 according to the photographing restrain information stored in the memory unit 111. So, even though the user turns on the CCD camera 107 to photograph the subject 105, the control unit 117 prevents the CCD camera 107 from operating normally.

Then, when the user leaves the area 121 (where photographing is prohibited) through the exit 121b, the short-distance wireless communication unit 113 of the portable communication terminal 103 receives the reset signal transmitted from the reset signal transmitter 125. The thus received signal is transferred to the control unit 117 from the short-distance wireless communication unit 113. Upon reading the reset signal, the control unit 117 resets the photographing restrain information stored in the memory unit 111.

In the meantime, the above-mentioned photographing restrain system has the disadvantage that if the short-distance wireless communication unit 113 of the portable communication terminal 103 fails to receive the reset signal from the reset signal transmitter 125 when the user carrying the portable communication terminal 103 leaves the area 121 where photographing is prohibited through the exit 121b, the photographing restrain imposed on the portable communication terminal 103 will not be removed. It follows therefore that if the user leaves the area 121 where photographing is prohibited while the portable communication terminal 103 has not yet received the reset signal from the reset signal transmitter 125, the photographing restrain remains imposed on the portable communication terminal 103 even when the user is outside the area 121 where photographing is prohibited.

This disadvantage will be eliminated if the photographing restrain information transmitting unit 123 is modified such that it wirelessly transmits the photographing restrain information together with the timing action starting instruction. Thus, upon passing through the entrance 121a, the portable communication terminal 103 (carried by the user) receives the photographing restrain information together with the timing action starting instruction. Then, the control unit 117 starts timing, and when the measured time length has reached the previously set time length, the photographing restrain imposed on the portable communication terminal 103 is removed. In this way it is possible to avoid the above-mentioned problem even when the portable communication terminal 103 fails to receive the reset signal from the rest signal transmitter 125.

As mentioned above, the second embodiment of the photographing restrain system according to the present invention works in such a way that the photographing restrain information transmitting unit 123 down-loads the photographing restrain information into the portable communication terminal 103 passing through the entrance 121a of the area (or the facility such as theater and movie theater) where photographing is prohibited. Therefore, it produces almost the same effect as the first embodiment mentioned above. In addition, it does not need the photographing restrain information transmitting unit 123 for individual subjects for which photographing is prohibited. This makes the system simple and inexpensive.

Moreover, if the user entering the area 121 where photographing is prohibited pays charge for photographing the subject 105 to the administrator of the facility, the administrator will permit the user to photograph the subject 105 and limit the number of pictures to be taken of the subject 105. Thus, the administrator would be able to charge for the photographing of the forbidden subject 105. Incidentally, the down-loading of the photographing restrain information from the photographing restrain information transmitting unit 123 may take place not only when the user passes through the entrance 121a but also at any time and any place while the user is in the forbidden area 121. Moreover, this embodiment may also be applicable to a digital video camera as well as the portable communication terminal 103 equipped with the CCD camera 107.

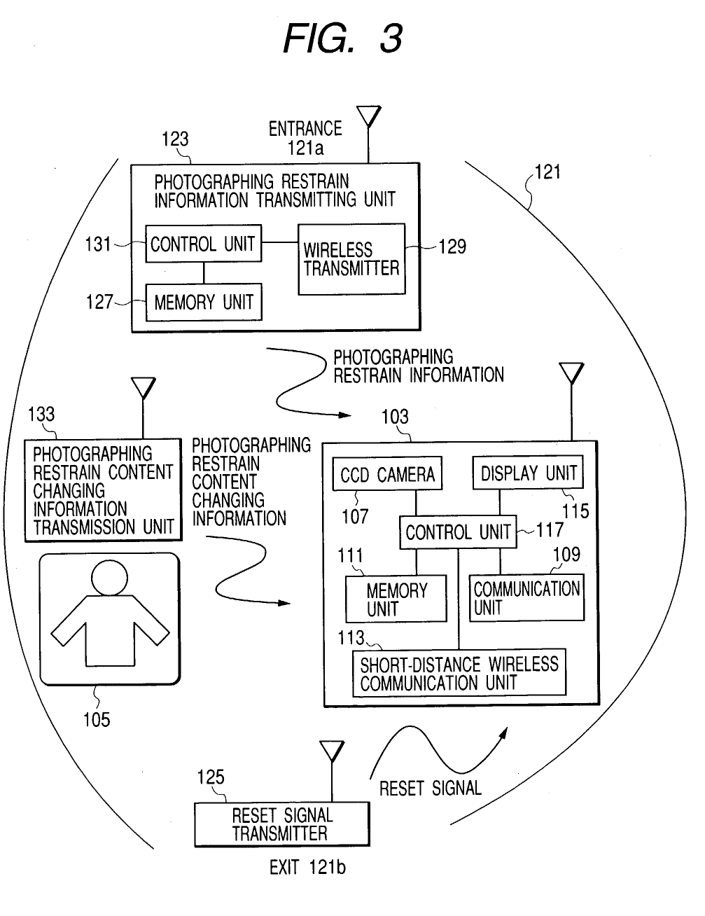

FIG. 3 is a block diagram showing the third embodiment of the photographing restrain system according to the present invention.

As shown in FIG. 3, the photographing restrain system is identical with that shown FIG. 2 except that the photographing restrain content changing information transmission unit 133 is installed for each of the forbidden subjects 105 in the forbidden area 121. (For the sake of simple illustration, one each of 105 and 133 is shown in FIG. 3.) The photographing restrain content changing information transmission unit 133 transmits the photographing restrain content changing information which changes the content of the photographing restrain information which has been down-loaded from the photographing restrain information transmitting unit 123 into the portable communication terminal 103 of the user passing through the entrance 121a. The photographing restrain content changing information transmission unit 133 also wirelessly transmits, in addition to the photographing restrain content changing information, information to the portable communication terminal 103 telling that photographing restrain is imposed on the subject 105.

In other words, the above-mentioned system works in such a way that when the user photographs the forbidden subject 105 using the portable communication terminal 103, the portable communication terminal 103 receives the photographing restrain content changing information from the photographing restrain content changing information transmission unit 133 and adds this information to the photographing restrain information from the photographing restrain information transmitting unit 123. In this way it is possible to change the content of photographing restrain for each subject 105.

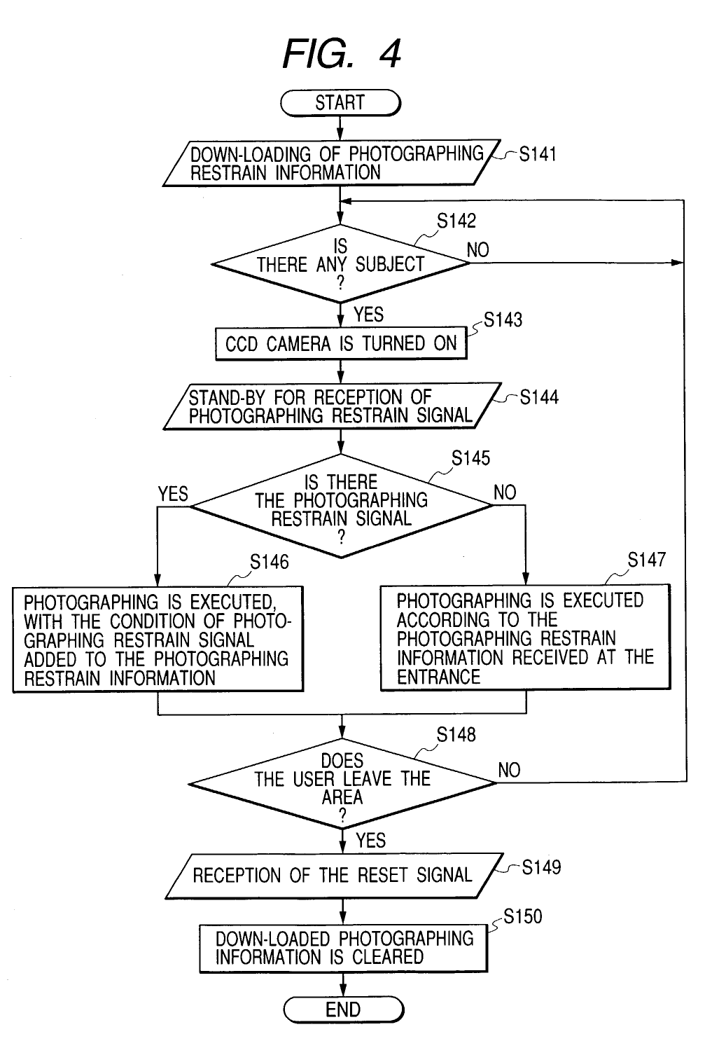

The operation of the photographing restrain system constructed as mentioned above will be explained below with reference to FIG. 4 (flowchart).

In FIG. 4, as the user carrying the portable communication terminal 103 passes through the entrance 121a of the area 121 where photographing is restrained, the short-distance wireless communication unit 113 of the portable communication terminal 103 receives the photographing restrain information from the wireless transmitter 129 of the photographing restrain information transmitting unit 123, and the received information is down-loaded into the memory unit 111 of the portable communication terminal 103. (Step S141) Then, the user finds the object 105 in the area 121 where photographing is restrained and presses the start-up button (not shown) of the operating unit (not shown) of the CCD camera of the portable communication terminal 103. The control unit 117 is informed of the operation of the operating unit (in Step S142—Yes). Then the control unit 117 turns on the CCD camera 107 and makes the portable communication terminal 103 ready for photographing. (Step S143) Then, the control unit 117 turns on the short-distance wireless communication unit 113, thereby making it ready to receive the photographing restrain content changing information (corresponding to the object 105) from the photographing restrain content changing information transmission unit 133. (Step S144) If the short-distance wireless communication unit 113 receives the photographing restrain content changing information in the stand-by state (Step S145—Yes), then the portable communication terminal 103 executes the photographing of the subject 105 under the condition that the content of the photographing restrain content changing information is added to the photographing restrain information which has been down-loaded from the photographing restrain information transmitting unit 123 in Step S141. (Step S146)

On the other hand, if the short-distance wireless communication unit 113 does not receive the photographing restrain content changing information in the stand-by state (Step S145—No), the portable communication terminal 103 executes the photographing of the subject 105 based on the photographing restrain information which has been down-loaded from the photographing restrain information transmitting unit 123 in Step S141. (Step S147) Incidentally, the actions in Step S142 to Step S146 or Step s147 are continued until the start-up button (not shown) of the CCD camera is turned off by the user or until any other action is taken which suggests that the user intends to leave the forbidden area 121. (Step S147—No)

Then, if it is confirmed that the user intends to leave the forbidden area 121 through the exit 121b (Step S148—Yes), the short-distance wireless communication unit 113 receives the reset signal from the reset signal transmitter 125 (Step S149) and it is output to the control unit 117 from the short-distance wireless communication unit 113. Upon reading the reset signal, the control unit 117 resets the photographing restrain information stored in the memory unit 111. (Step S150)

As mentioned above, the third embodiment of the photographing restrain system of the present invention produces the same effect as the second embodiment. In addition, it is additionally equipped with the photographing restrain content changing information transmission unit 133 for each subject 105, so that it receives from 133 the photographing restrain chaining information for each subject 105 when the user photographs the subject 105 using the portable communication terminal 103. This provision makes it possible to change the content of the photographing restrain for individual subject 105 in the forbidden area 121. Moreover, this embodiment may also be applicable to a digital video camera as well as the portable communication terminal 103 equipped with the CCD camera 107.

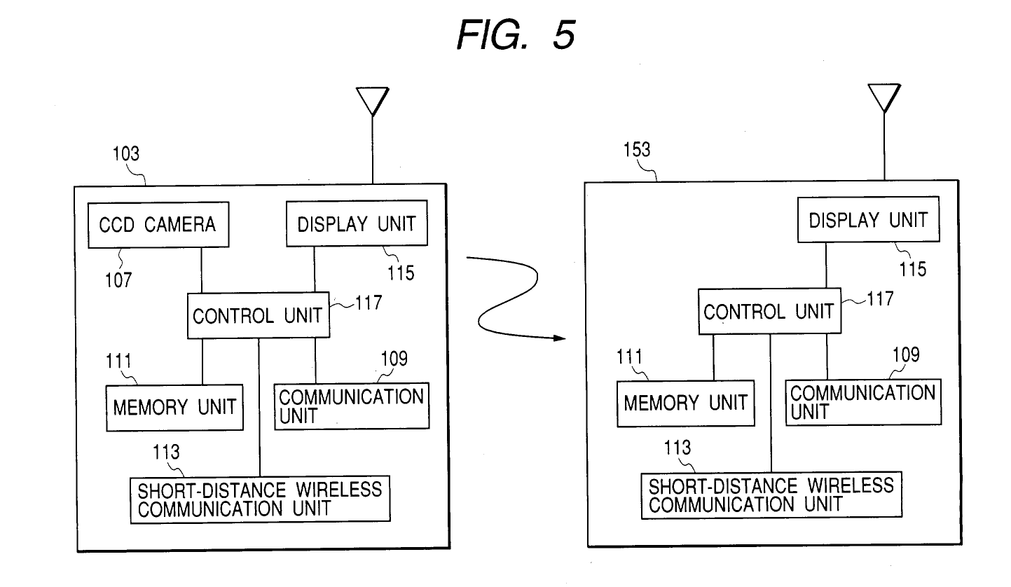

FIG. 5 is a block diagram showing one embodiment of the photographing warning system according to the present invention.

As shown in FIG. 5, the photographing warning system consists of the portable communication terminal 103 which is equipped with a digital camera (or CCD camera) and the portable communication terminal 153 which is not equipped with a digital camera (or CCD camera). The portable communication terminal 103 and the portable communication terminal 153 are identical in structure except that only the former is equipped with the CCD camera 107. In other words, both the portable communication terminals 103 and 153 have the communication unit 109, the memory unit 111, the short-distance wireless communication unit 113, the display unit 115, and the control unit 117, which function as explained above with reference to FIGS. 1 to 3.

Incidentally, the short-distance wireless communication unit 113 employs Bluetooth (a trademark of Bluetooth SIG, Inc. USA) as mentioned above. While kept on continuously, the short-distance wireless communication unit 113 transmits continuously to the soundings the photographing start information (informing that the portable communication terminal 103 will start the photographing action). While kept on intermittently, the short-distance wireless communication unit 113 transmits intermittently to the soundings the photographing start information.

The photographing warning system constructed as mentioned above works in the following manner when a user carrying the portable communication terminal 103 enters a forbidden area to take pictures.

Referring to FIG. 5, it is assumed that one user carrying the portable communication terminal 103 turns on the CCD camera 107 (or turns the portable communication terminal 103 into its photographing mode). At this time, the short-distance wireless communication unit 113 is also turned on, and it transmits continuously or intermittently the photographing start information to the surroundings.

On the other hand, it is assumed that the other user carrying the portable communication terminal 153 keeps the short-distance wireless communication unit 113 on continuously or intermittently. Then, the portable communication terminal 153 receives continuously or intermittently the photographing start information which is being transmitted continuously or intermittently from the short-distance wireless communication unit 113 of the portable communication terminal 103, and it outputs the photographing start information to the control unit 117. Upon reading the photographing start information, the control unit 117 actuates a speaker (not shown) built into the portable communication terminal 153, thereby producing a warning sound, or actuates the display unit 115, thereby displaying a warning message on the display unit 115, or actuates a vibration mechanism (not shown), thereby informing the user carrying the portable communication terminal 153 that someone is going to take pictures nearby.

Incidentally, the portable communication terminal 103 may be constructed such that it not only transmits wirelessly the photographing start information but also produces a mimic shutter sound when the user takes a picture. This provision will let anybody (who does not carry the portable communication terminal 153) know that someone is going to take a picture. Also, a digital photographing apparatus (such as video camera) capable of continuous photographing may be constructed such that it wirelessly transmits continuously or intermittently a warning that someone is taking pictures.

As mentioned above, one embodiment of the photographing warning system according to the present invention functions in such a way that when a user attempts to take a picture by using the CCD camera 107 of his portable communication terminal 103, the portable communication terminal 103 produces a warning sound so that the subject 105 and others are protected from stealthy photographing, or wirelessly transmits the photographing start information to the surroundings of the portable communication terminal 103 through the short-distance wireless communication unit 113, thereby telling the surrounding people that someone is going to take pictures. In this way it is possible to prevent stealthy photographing.

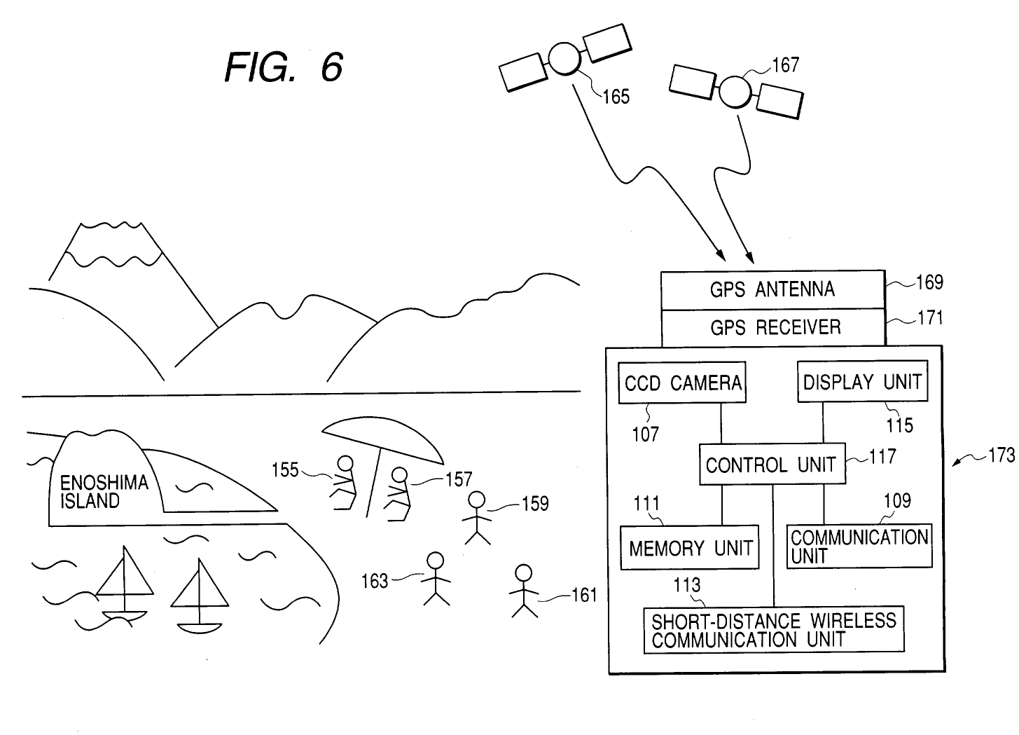

FIG. 6 is a diagram illustrating by example the application of the photographing restrain system of the present invention to an outdoor site where unconditional photographing is prohibited.

In the case shown in FIG. 6, the outdoor site where unconditional photographing is prohibited is Shonan Beach in summer which is crowded with young girls in bathing suit. (Young girls are indicated by 155, 157, 159, 161, and 163.) The system employs the portable communication terminal 173 which has not only the same construction as the above-mentioned portable communication terminal 103 but also the GPS antenna 169 to receive radio waves from a plurality of GPS satellites (165 and 167) and the GPS receiver 171 to obtain the position information from the received radio waves.

If the position information obtained by the GPS receiver 171 indicates that the user carrying the portable communication terminal 173 is in Shonan Beach, then the control unit 117 prevents the CCD camera 107 from photographing operation or restrains itself from writing the image data into the memory unit 111. Thus it is possible to protect young girls (155-163) in bathing suit from being photographed by someone without notice. In this way their right of portrait is protected.

Incidentally, the same effect as mentioned above may be produced even in the case where the young girls (155-163) individually carry the photographing restrain information transmitting unit 101 as shown in FIG. 1. In this case the photographing restrain information transmitting unit 101 wirelessly transmits the photographing restrain information continuously or intermittently as mentioned above. In this way it is possible to protect the young girls in bathing suit from being photographed by the user carrying the portable communication terminal 103 who approaches them a certain distance away. Incidentally, FIG. 6 shows the case of photographing with the portable communication terminal 103 equipped with the CCD camera 107. However, the same procedure as shown in FIG. 6 is also applicable to photographing with a digital video camera.

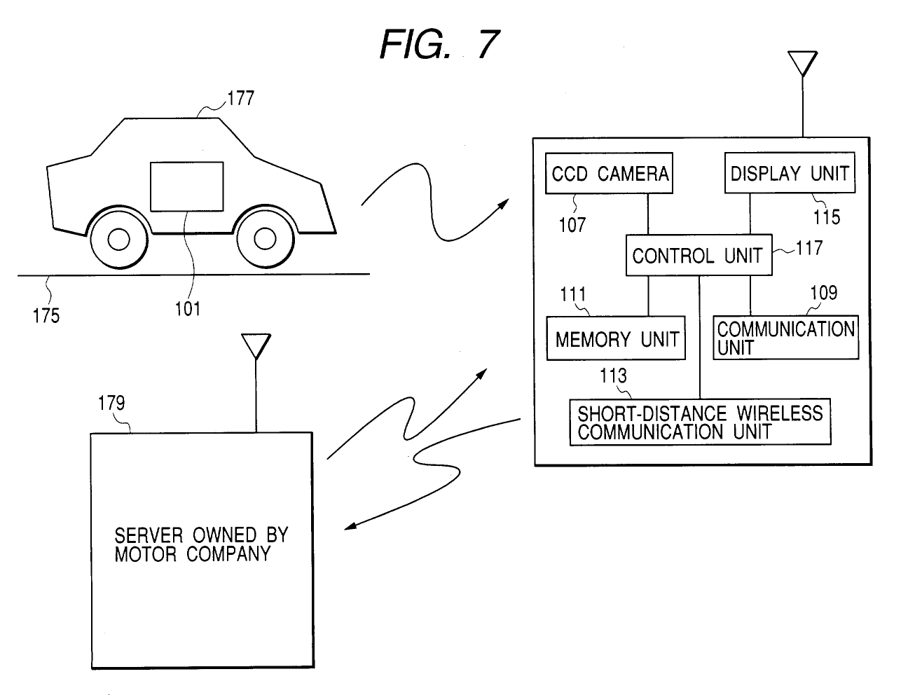

FIG. 7 is a diagram illustrating by example the application of the photographing restrain system of the present invention to an outdoor site where unconditional photographing is prohibited.

In the case shown in FIG. 7, the outdoor site where unconditional photographing is prohibited is a test course for a new model car which is under control by a motor company. According to this system, the new model car 177 running on the test course 175 is provided with the photographing restrain information transmitting unit 101 (as shown in FIG. 1) which wirelessly transmits the photographing restrain information continuously or intermittently. Thus the new model car 177 is protected from stealthy photographing by the user carrying the portable communication terminal 103 who approaches the test course a certain distance away. In addition, this system has a server 179 (under control by the motor company) which gives through wireless communication various information to the portable communication terminal 103 carried by the user who intends to photograph the new model car 177.

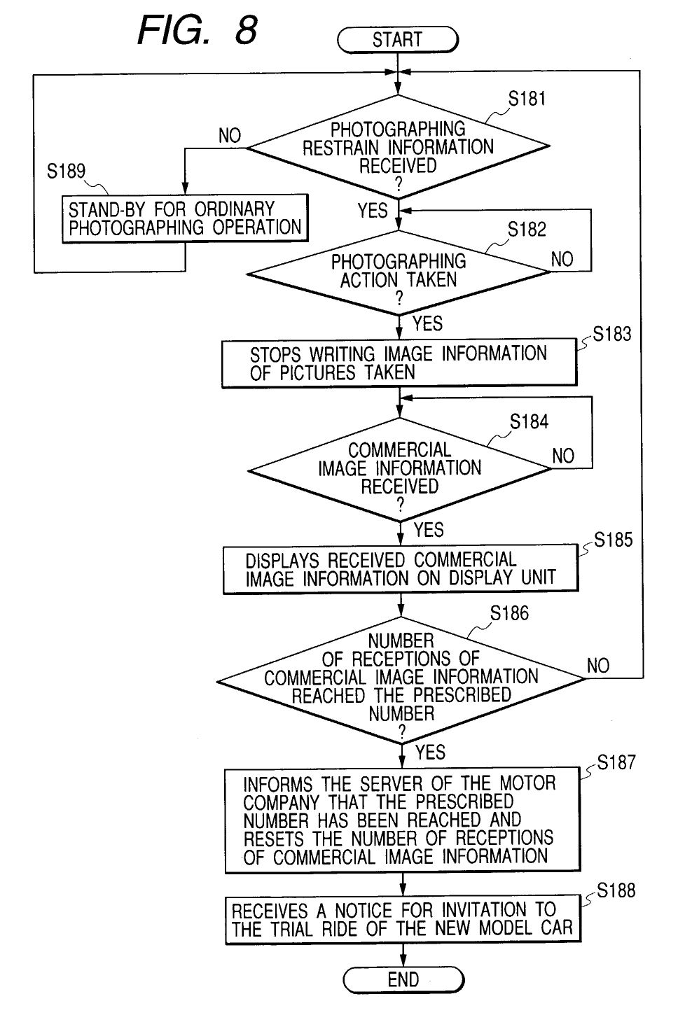

FIG. 8 is a flowchart showing operations in each unit of the photographing restrain system of FIG. 7.

In FIG. 8, the system works as follows. When a user approaches the test course 175 a certain distance away, the short-distance wireless communication unit 113 of his portable communication terminal 103 receives the photographing restrain information from the photographing restrain information transmitting unit 101 which is mounted on the new model car 177. (Step S181—Yes) Then, the system checks to see if the CCD camera 107 took a picture by the user's operation. (Step S182) If it is known that the CCD camera 107 took a picture (Step S182—Yes), then the control unit 117 stops writing the image information (from the CCD camera 107) in the memory unit 111. (Step S183)

Next, the control unit 117 checks to see if the short-distance wireless communication unit 113 has received the commercial image information of the motor company from the server 179 owned by the motor company. The commercial image information may be a superimposed dialogue indicating the price of the new model car 177. (Step S184) If it is known from this checking that the short-distance wireless communication unit 113 has received the commercial image information (Step S184—Yes), then the control unit 117 displays the commercial image information on the display unit 115 (Step S185) and also adds “1” to the reception number counter in the memory unit 111. Next, the control unit 117 checks the count value of the reception number counter in order to see whether or not the number of reception of the commercial image information (received from the short-distance wireless communication unit 113) has reached the prescribed number (Step S186). If it is found from this checking that the number of reception of the commercial image information does not reach the prescribed number (Step S186—No), then the flow returns to Step S181.

On the other hand, if it is found from this checking that the number of reception of the commercial image information has reached the prescribed number (Step S186—Yes), then the control unit 117 informs the short-distance wireless communication unit 113 through the server 179 that the number of reception of the commercial image information has reached the prescribed number. Then the control unit 117 rests the count value of the reception number counter. (Step S187) If there is a notice from the server 179 for invitation to the trial ride of the new model car, then the control unit 117 receives the notice through the short-distance wireless communication unit 113. (Step S188) If the photographing restrain information is not received in Step S181, then the control unit 117 operates the CCD camera 107 such that the portable communication terminal 103 (CCD camera 107) can take pictures in the usual way without any restrain. (Step S189)

Incidentally, the commercial image information which is wirelessly transmitted to the portable communication terminal 103 from the server 179 is not limited to that of the motor company; it may be any commercial image information requested by any firms other than the motor company. In this case, of course, the motor company will obtain the advertisement fees from the firms who requested advertisement. Incidentally, FIGS. 7 and 8 show the case of photographing with the portable communication terminal 103 equipped with the CCD camera 107. However, the same procedure as shown in FIGS. 7 and 8 is also applicable to photographing with a digital video camera.

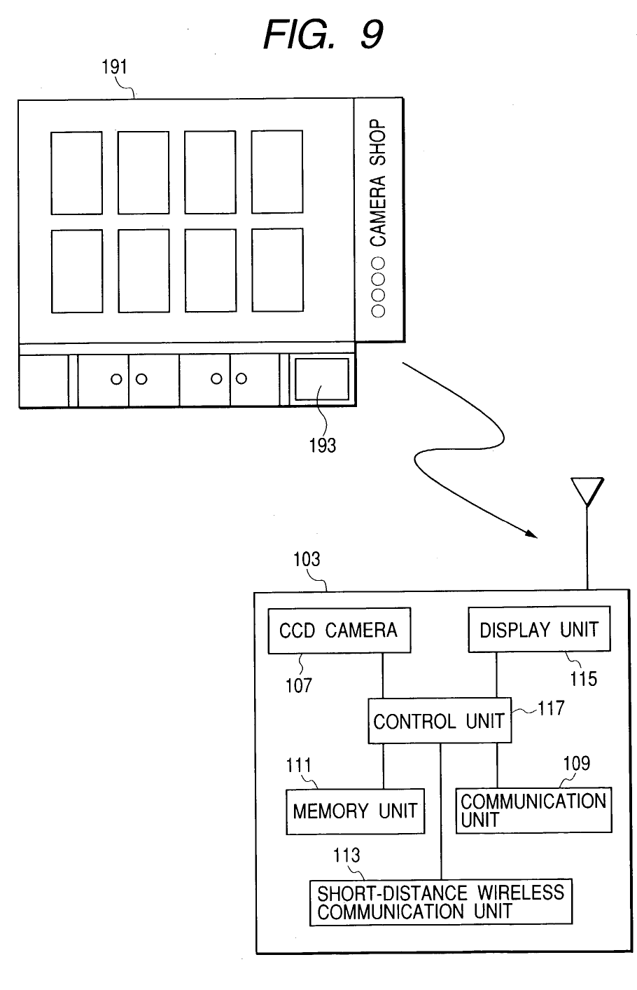

FIG. 9 is a diagram illustrating by example the commercial information providing system that employs the portable communication terminal according to the present invention.

The system shown in FIG. 9 works as follows. It is assumed that a user carrying the portable communication terminal 103 is passing by a camera shop 191 (which is a mass merchandiser of electric appliances). When this user takes a picture using the portable communication terminal 103 equipped with the CCD camera 107, the server 193 installed in this camera shop 191 wirelessly transmits commercial information (in the form of image information) for the camera shop to the portable communication terminal 103.

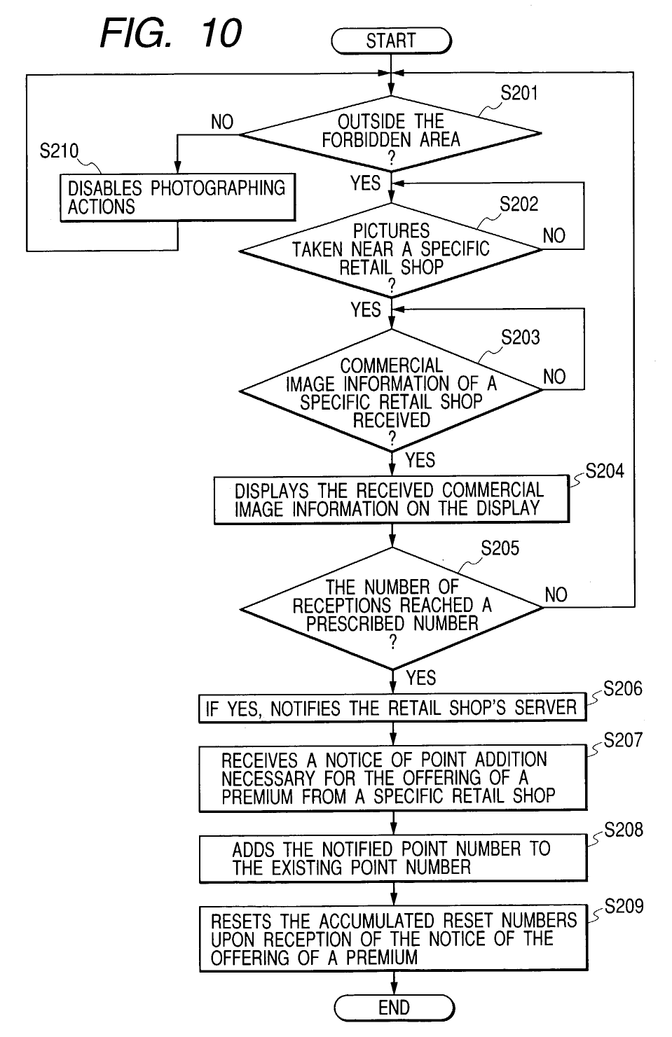

FIG. 10 is a flowchart showing operations in each unit of the commercial information providing system of FIG. 9.

In FIG. 10, it is assumed that the present position of the user carrying the portable communication terminal 103 is outside the area where photographing is prohibited. In this case the short-distance wireless communication unit 113 does not receive the photographing restrain information from the photographing restrain information transmitting unit 101 as shown in FIG. 1. (Step S201—Yes) Consequently, the control unit 117 controls the CCD camera 107 in such a way that the CCD camera 107 of the portable communication terminal 103 can take pictures in the usual way without any restrictions. Next, the control unit 117 checks to see if the CCD camera 107 took pictures in the neighborhood of the camera shop 191. (Step S202) If it is found by this checking that the CCD camera 107 took pictures (Step S202—Yes), then the control unit 117 checks to see if the short-distance wireless communication unit 113 has received the commercial image information from the server 193 owned by the camera shop 191. (Step S203)

If it is found by this checking that the short-distance wireless communication unit 113 has received the commercial image information (Step S203—Yes), then the control unit 117 displays the commercial image information on the display unit 115 (Step S204) and adds “1” to the reception number counter in the memory unit 111. Next, the control unit 117 checks the count value of the reception number counter in order to see whether or not the number of reception of the commercial image information (received by the short-distance wireless communication unit 113) has reached the prescribed number (Step S205). If it is found from this checking that the number of reception of the commercial image information does not reach the prescribed number (Step S205—No), then the flow returns to Step S201.

On the other hand, if it is found from this checking that the number of reception of the commercial image information has reached the prescribed number (Step S205—Yes), then the control unit 117 informs the short-distance wireless communication unit 113 through the server 193 that the number of reception of the commercial image information has reached the prescribed number. Then the control unit 117 rests the count value of the reception number counter. (Step S206) When the short-distance wireless communication unit 113 receives from the server a notice of point addition for the user to receive a premium (or a gift) from the camera shop 191 (Step S207), the control unit 117 adds the informed point number to the point number counter in the memory unit 111. (Step S208)

Next, when the short-distance wireless communication unit 113 receives the notice of the offer of a premium from the server 193, the control unit 117 resets the count value of the point number counter and completes a series of processing (Step S209). If the photographing restrain information is received in Step S201, the control unit 117 disables the CCD camera 107. (Step S210) (In other words, the CCD camera 107 of the portable communication terminal 103 becomes unable to take pictures in the usual way on account of the photographing restrain information.) Incidentally, the commercial image information which is wirelessly transmitted to the portable communication terminal 103 from the server 193 in Step S203 is not limited to that of the camera shop 191; however, it may be any commercial image information requested by other firms. In this case, the camera shop 191 gains the advertisement fee from the firm who requested advertisement, as a matter of course. Incidentally, FIGS. 9 and 10 show the case of photographing with the portable communication terminal 103 equipped with the CCD camera 107. However, this procedure is also applicable to photographing with a digital video camera.

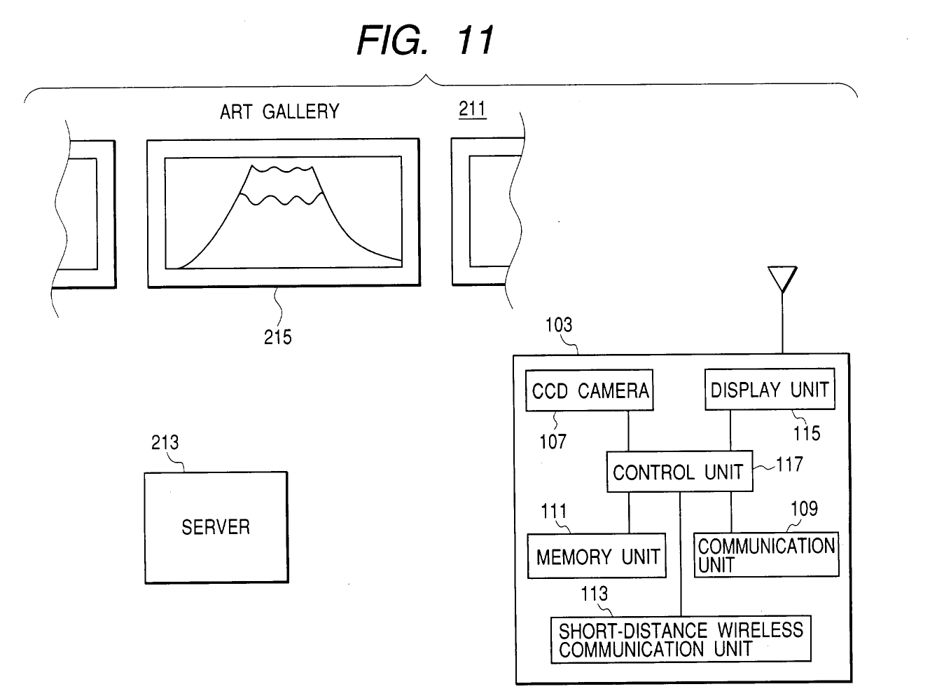

FIG. 11 is a diagram illustrating by example the photographing restrain release system that employs the portable communication terminal according to the present invention.

The system shown in FIG. 11 is constructed as follows. It is assumed that a user carrying the portable communication terminal 103 is in an art gallery 211 where photographing is prohibited. Then, the portable communication terminal 103 receives a notice of permission of photographing from the server 213 installed in the art gallery 211. In response to this notice, the portable communication terminal 103 informs the server 213 that the procedure necessary for the user to pay the photographing fee has completed. Thus, the portable communication terminal 103 becomes able to photograph the subject (painting 215 in this case). In addition, the portable communication terminal 103 has a function to edit and prints the image information of the painting 215 (as a subject) to make a picture postcard or to transfer the image information to another portable communication terminal 103. This function is realized by the editing-transferring program which is down-loaded from the server 213.

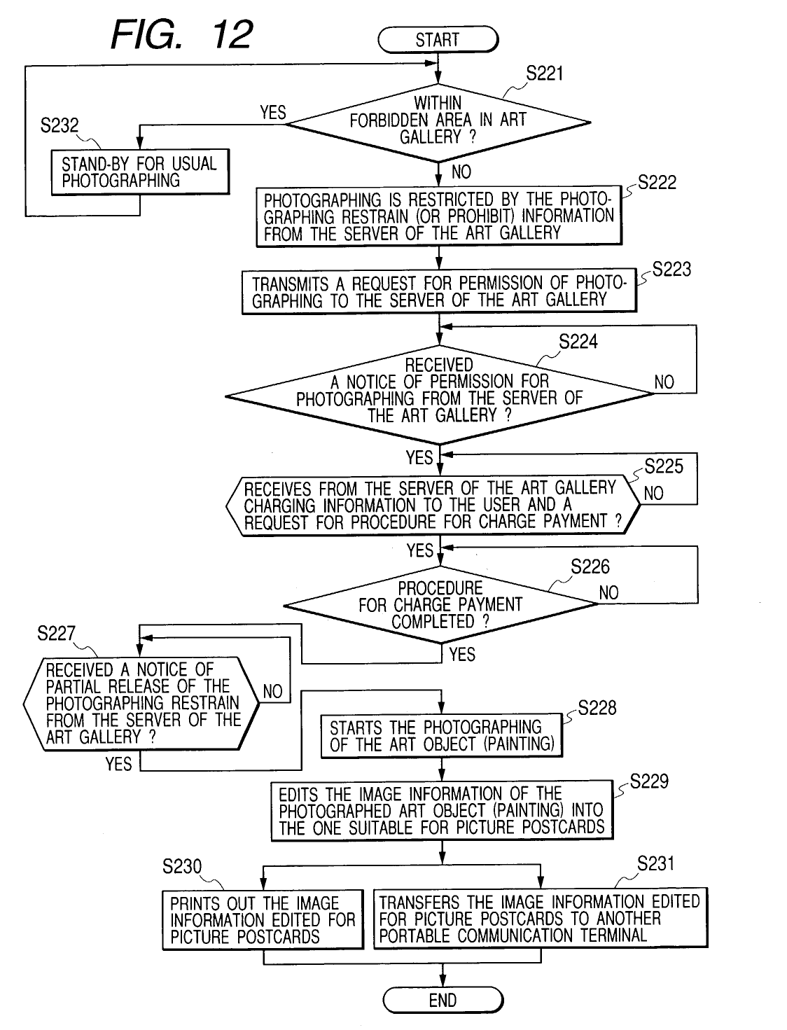

FIG. 12 is a flowchart showing operations in each unit of the photographing restrain release system of FIG. 11.

In FIG. 12, it is assumed that a user carrying the portable communication terminal 103 is in the art gallery 211 (Step S221—No). Then, the short-distance wireless communication unit 113 receives the photographing restrain information from the photographing restrain information transmitting unit 101 as shown in FIG. 1. At the same time, it also receives the editing-transferring program from the server 213. As the result, the control unit 117 restricts the action of the CCD camera 107 in response to the photographing restrain information. (Step S222) If the control unit 117 notices in this state that the user operates a specific button on the operating panel of the portable communication terminal 103, then it wirelessly transmits a request for permission of photographing to the server 213 through the short-distance wireless communication unit 113. (Step S223)

Next, the control unit 117 checks to see if the short-distance wireless communication unit 113 has received the notice of permission for photographing which was wirelessly sent from the server 213. (Step S224) If it is found from this checking that the short-distance wireless communication unit 113 has received the notice of permission for photographing (Step S224—Yes), the control unit 117 checks to see if the short-distance wireless communication unit 113 has received the information of charge for photographing the painting 215 and the demand for procedure of charge payment which are wirelessly transmitted from the server 213. (Step S225) If it is found from this checking that the short-distance wireless communication unit 113 has received the information of charging and the demand for procedure of charge payment (Step S225—Yes), then the control unit 117 checks to see if the user has completed the prescribed procedure for charge payment. The procedure for charge paying includes informing the card number of the user's credit card or the account number of the user's bank account to the server 213 through the portable communication terminal 103. (step S226)

If it is found from this checking that the prescribed procedure has been completed (Step S226—Yes), then the control unit 117 checks to see if the short-distance wireless communication unit 113 has received the notice of partial release of photographing restrain wirelessly transmitted from the server 213. (Step S227) Incidentally, the notice of partial release of photographing restrain is a notice informing that the photographing of a specific art object such as the painting 215 is allowed. If it is found from this checking that the short-distance wireless communication unit 113 has received the notice of partial release of photographing restrain (step S227—Yes), the CCD camera 107 starts the action of photographing the specific art object. (Step S228)

Next, the portable communication terminal 103 invokes the editing-transferring program mentioned above and then edits the image information of the photographed art object to make it suitable for picture postcards. (Step S229) Then, it processes the edited image information of an art object so that it will be printed later on (Step S230) or so that it will be transferred to another portable communication terminal 103 (Step S231). Thus a series of processing is completed. Incidentally, if the user carrying the portable communication terminal 103 is outside the forbidden area in the art gallery 211, then the short-distance wireless communication unit 113 does not receive the photographing restrain information from the photographing restrain information transmitting unit 101 (Step S221—Yes). In this case, the control unit 117 makes the CCD camera 107 possible to take pictures in the usual way without any restrictions. (Step S232) Incidentally, FIGS. 11 and 12 show the case of photographing with the portable communication terminal 103 equipped with the CCD camera 107. However, this procedure is also applicable to photographing with a digital video camera.

Some preferred embodiments of the present invention were mentioned in the foregoing; they are merely exemplary and do not intend to restrict the scope of the invention. They may be modified variously. For example, the photographing restrain release system shown in FIG. 11 may find use in the following situation. That is, it will be used to exceptionally permit people to take pictures in the facilities where photographing is prohibited, such as famous shrines and temples in tourist resorts like Nara, Kyoto, and Kamakura.

In this case the system may be used as follows. Ordinary visitors are required to pay a less amount of admission fee but visitors who want to take pictures are charged each time the photographing restrain is partly released. Alternatively, visitors pay the same admission fee as before but receive coupon tickets each time the photographing restrain is partly released, and visitors with the coupon tickets get a discount for their next visit. (This will help increase the number of repeating visitors.) The system may also be as follows. If visitors pay additional fee in the forbidden facilities, then the server in the facilities transfers text data relating to them to the portable communication terminal 103. Another possible arrangement is such that when visitors photograph shrines and temples using their portable communication terminal 103, the server in the facilities sends a variety of commercial (image) information. In this way the administrator of the facilities will obtain advertisement fee from sponsors.

The system shown in FIG. 11 may be used in such a way that if a visitor pays a prescribed fee in a famous tourist resort or amusement park, the server in the facility gives a message (informing the best photographing spot in the facility) to the visitor through his portable communication terminal 103, and the server provides a synthetic image in which the visitor's face is combined with the background image of the spot which the visitor has photographed with his portable communication terminal 103. In this case the visitor may transmit the synthetic image to his friend to inform his present position. In addition, the system shown in FIG. 11 may also be used in such a way that if a user takes a picture at a railway station using his portable communication terminal 103, then additional information (such as time table in the station) is transferred (for pay) to his portable communication terminal 103.

Incidentally, the charging processing may be carried out in such a way that a notice about photographing is sent from the portable communication terminal 103 to the telephone office through mobile communication networks which charges the users.

As mentioned above, according to the embodiments of the present invention, it is possible to surely prevent the photographing apparatus or the portable terminal having a photographing unit from taking pictures in an area where photographing is prohibited.

Also, according to the embodiments of the present invention, it is possible to surely prevent the photographing apparatus or the portable terminal having a photographing unit from taking pictures stealthily because the object (or surroundings) is informed that he or she is being photographed.

The foregoing invention has been described in terms of preferred embodiments. However, those skilled, in the art will recognize that many variations of such embodiments exist. Such variations are intended to be within the scope of the present invention and the appended claims.

What is claimed is:

1. A photographing apparatus which comprises
an electrically controlled photographing unit,
a signal receiving unit to receive signals from an external remote apparatus, and
a control unit which, when the signal output from the signal receiving unit is a control signal relating to the control of photographing by the photographing unit, responds the control signal, thereby controlling the photographing action or the action relating to photographing of the photographing unit, wherein
said photographing control unit in response to said control signal performs any of restricting the number of pictures to be taken, prohibiting the use of flash at the time of photographing, restraining the image data of photographed pictures from being stored in the memory unit in the photographing apparatus or being output to an external apparatus, charging for photographing, and continuing said control for a prescribed period of time after reception of said control and subsequently releasing said control.

2. A photographing apparatus which comprises
an electrically controlled photographing unit,
a signal receiving unit to receive signals from an external remote apparatus, and
a control unit which, when the signal output from the signal receiving unit is a control signal relating to the control of photographing by the photographing unit, responds the control signal, thereby controlling the photographing action or the action relating to photographing of the photographing unit, wherein
said apparatus being housed in a casing which has a camera part which is exposed to outside at the time of photographing and an antenna part to receive said control signal, with both parts arranged close to each other so that if said antenna part is covered with a signal shielding material, said camera part is also covered by the signal shielding material.

3. A photographing restrain system which comprises
a photographing apparatus and
a photographing control signal transmitting apparatus to send photographing control signals to said photographing apparatus, wherein
said photographing apparatus having
an electrically controlled photographing unit,
a signal receiving unit to receive signals from an external remote apparatus, and
a photographing control unit which, when the signal output from the signal receiving unit is a photographing control signal relating to the control of photographing by the photographing unit which has been transmitted from the photographing control signal transmitting apparatus, in response to the photographing control signal, controls the photographing action of the photographing unit or control the action relating to photographing, and wherein
said photographing control signal transmitting apparatus being arranged at an entrance of a closed space area where photographing is prohibited throughout.

4. The photographing restrain system as defined in claim 3, wherein the exit of the closed space area is equipped with a photographing restrain release signal transmitting unit to transmit a photographing restrain release signal so that said photographing restrain is released when the photographing apparatus, which has been restrained from taking pictures by the photographing restrain signal transmitted from the photographing control signal transmitting apparatus, passes through the exit.

5. The photographing restrain system as defined in claim 3, wherein each of a plurality of photograph objects arranged in the closed space area is provided with a photographing restrain changing signal transmitting apparatus to send said photographing apparatus a signal to change the photographing restrain imposed on said photographing unit by the photographing restrain signal transmitted from said photographing control signal transmitting apparatus.

6. A photographing restrain release system which comprises
a photographing apparatus and
a server which interchanges information with said photographing apparatus present in a space area where photographing is restricted, wherein
said photographing apparatus having
an electrically controlled photographing unit,
a judging unit to judge based on information given from outside whether or not photographing restrain is imposed on the object or space area to be photographed by the photographing unit,
a release request transmitting unit to transmit a request for release of photographing restrain to the server when the judging unit judges that photographing restrain is imposed,
an executing unit which, when conditions necessary for the photographing restrain to be released are proposed from the server, executes processing to meet said conditions, and
a photographing restrain release unit to release restrain imposed on the photographing action of the photographing unit when a notice of photographing restrain release is given from the server, wherein
said server having
an exhibiting unit to exhibit conditions for photographic restrain release upon receipt of request for photographing restrain release from said photographing apparatus,
a verifying unit to verify whether or not said conditions are satisfied when there is a notice to the effect that the conditions for photographing restrain release from the photographing apparatus, and
a photographing restrain release notifying unit to inform the photographing apparatus that the photographing restrain is released when the verifying unit has verified that the conditions are satisfied.
